(19) United States
(12) Patent Application Publication
(10) Pub. No.: US 2011/0271470 A1
(43) Pub. Date: Nov. 10, 2011

(54) Brush Assembly with Non-Rotating Stabilizer and Brushes

(75) Inventors: Gregory L. Hern, Porter, TX (US); Courtney J. Hartmann, Houston, TX (US); Thomas M. Ashy, Lafayette, LA (US)

(73) Assignee: Baker Hughes Incorporated, Houston, TX (US)

(21) Appl. No.: 12/773,346

(22) Filed: May 4, 2010

(51) Int. Cl. B08B 9/00

(52) U.S. Cl. 15/104.09

(57) ABSTRACT

A brush assembly for cleaning a surrounding tubular member. The brush assembly includes a brush portion that is rotationally moveable with respect to a central tool mandrel and debris chamber. The brush portion includes at least one brush and a stabilizer.

### BACKGROUND OF THE INVENTION

1. Field of the Invention

The invention relates generally to systems and methods for cleaning wellbores or other surrounding tubulars. In particular aspects, the invention relates to the design of brush devices used to clean such tubulars.

2. Description of the Related Art

Brush assemblies are used to clean the interior of risers, casing, liners and other tubular members within a wellbore. Conventional brush assemblies are described in, for example, U.S. Pat. No. 3,176,772 issued to MacGregor.

### SUMMARY OF THE INVENTION

The invention provides an improved brush assembly for the cleaning of wellbore tubulars. In an exemplary embodiment, a brush assembly in accordance with the present invention includes a rotational interface which permits the brush to rotate with respect to a central mandrel. The exemplary brush assembly includes a brush portion that is rotationally mounted about a mandrel. In addition, the brush portion includes an alternating stack of brushes and spacers that are located axially between a pair of stabilizers. The stabilizers preferably extend radially outwardly to a diameter that is greater than the diameter provided by any other solid component of the brush assembly. It is further preferred that the diameter of the stabilizers approximates the drift diameter for the tubular being cleaned. The distal ends of the brushes extend radially outwardly beyond the diameter of the stabilizers.

In a further aspect of the present invention, the brush assembly further preferably includes a debris collection chamber which is defined radially within an outer housing of the brush assembly and which collects and retains debris that has been loosened or removed from the surrounding tubular by the brushes. The chamber includes at least one surface or structure which is magnetized in order to attract and retain metallic debris within the chamber.

### BRIEF DESCRIPTION OF THE DRAWINGS

The advantages and further aspects of the invention will be readily appreciated by those of ordinary skill in the art as the same becomes better understood by reference to the following detailed description when considered in conjunction with the accompanying drawings in which like reference characters designate like or similar elements throughout the several figures of the drawing and wherein:

FIG. 1 is a side, external view of an exemplary riser brush assembly constructed in accordance with the present invention.

FIG. 2 is a side, cross-sectional view of the riser brush assembly shown in FIG. 1.

FIG. 3 is an axial, cross-sectional view taken along lines 3-3 in FIG. 2.

FIG. 4 is an enlarged, side view, partially in cross-section, of the brush portion of the brush assembly shown in FIGS. 1-3.

FIG. 5 is an exploded view depicting several components of the riser brush assembly shown in FIGS. 1-4.

FIG. 6 is a side, cross-sectional view of an exemplary riser brush assembly being used to clean a surrounding tubular.

### DETAILED DESCRIPTION OF THE PREFERRED EMBODIMENTS

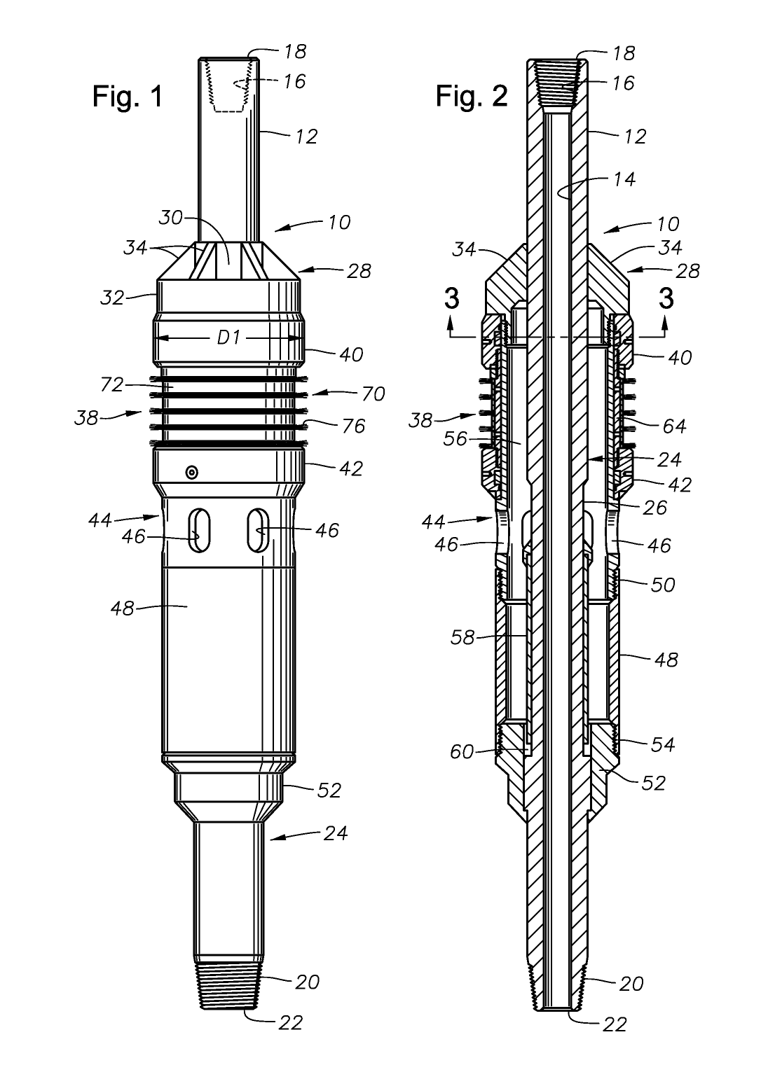

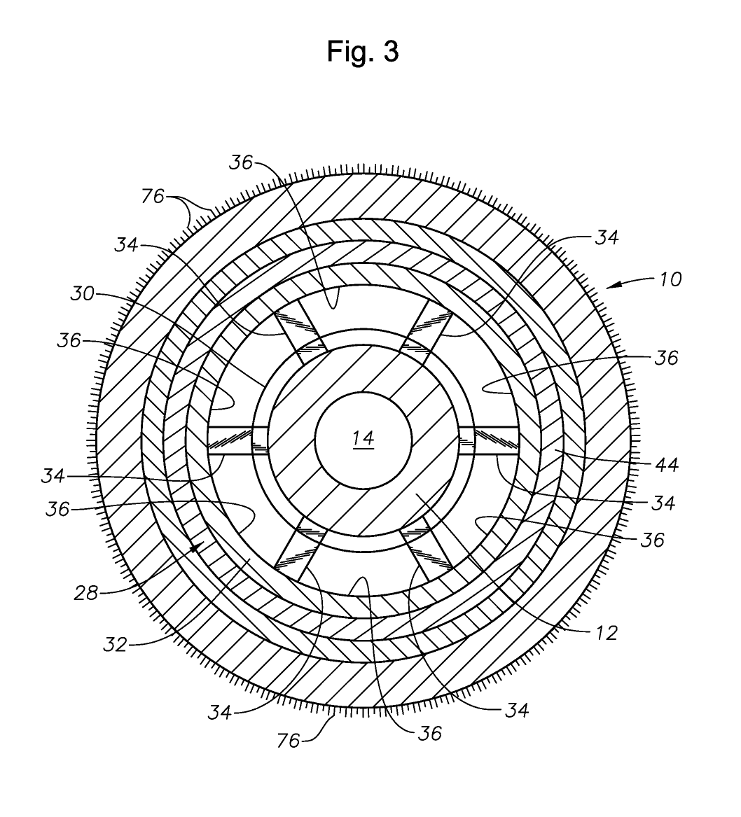

FIGS. 1-4 illustrate an exemplary brush assembly 10 that is constructed in accordance with the present invention. The brush assembly 10 includes a generally cylindrical tool mandrel 12 that defines a central axial flowbore 14 along its length. A box-type threaded connection 16 is formed proximate the upper axial end 18 of the mandrel 12. A pin-type threaded connection 20 is formed proximate the lower end 22 of the mandrel 12. The tool mandrel 12 presents an outer radial surface 24 with a reduced-diameter portion 26.

A flow entry sub 28 radially surrounds the tool mandrel 12 proximate the upper end 18. The flow entry sub 28 includes an inner annular collar 30 and an outer annular collar 32. The inner and outer collars 30, 32 are interconnected by a plurality of radial ribs 34. A plurality of axial fluid flow passages 36 are defined between the collars 30, 32 and the ribs 34.

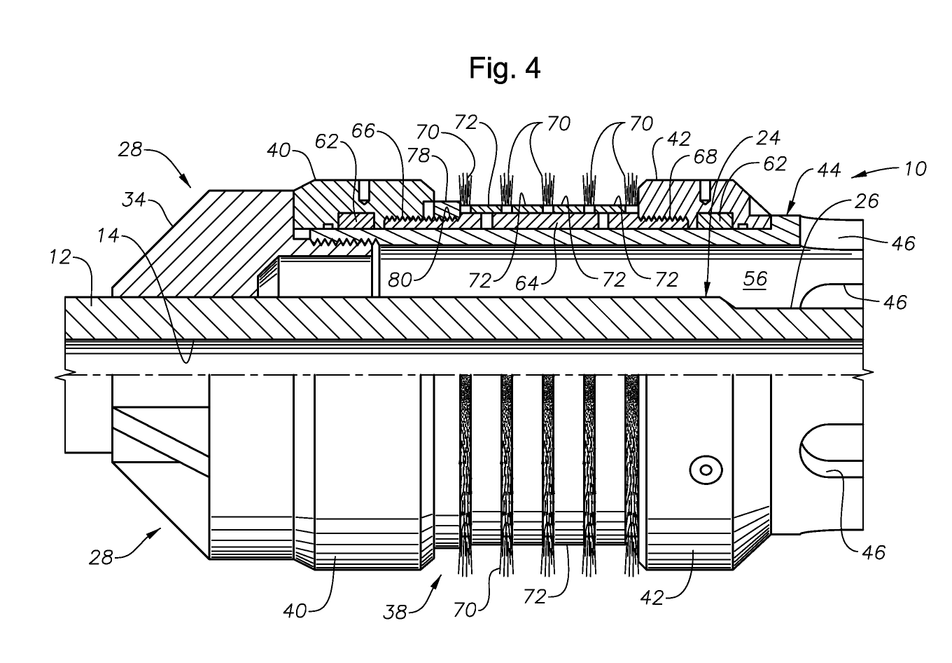

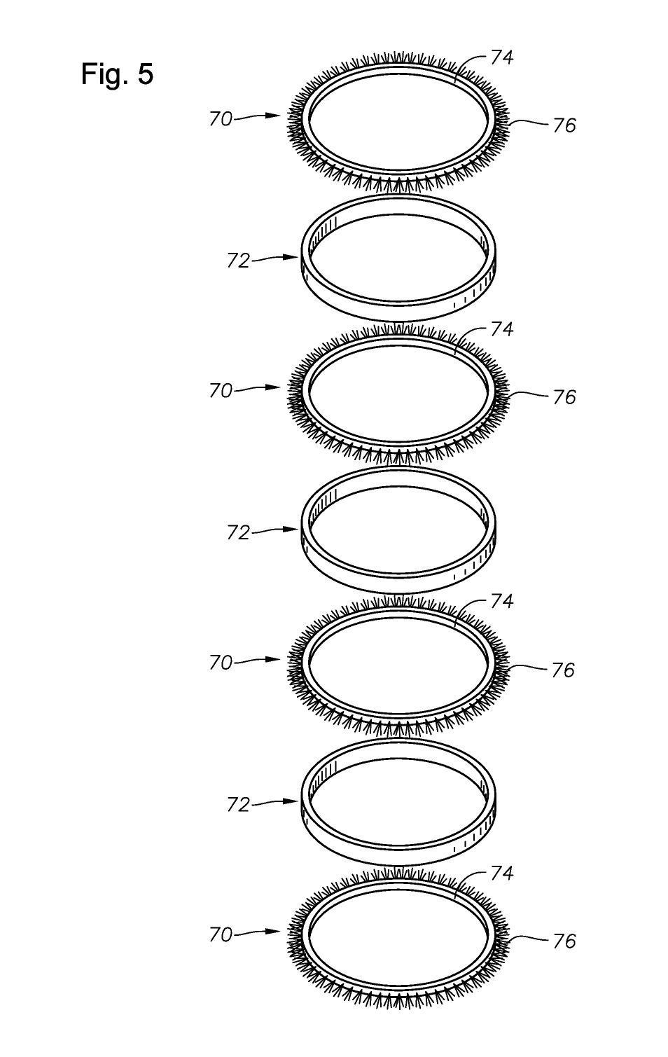

A brush portion, generally shown at 38, is located below the flow entry sub 28. The brush portion 38 is shown in greater detail in FIGS. 4 and 5. The brush portion 38 includes upper and lower stabilizers 40, 42, respectively. The stabilizers 40, 42 each extend radially outwardly to an outer diameter D1 that is greater than any of the other solid components of the brush assembly 10. It is further preferred that the diameter D1 approximate drift diameter for the particular outer tubular (not shown) into which the assembly 10 will be run to conduct brush cleaning operations.

A debris chamber housing 44 radially surrounds the tool mandrel 12 below the flow entry sub 28. The debris chamber housing 44 includes a plurality of debris windows 46. A housing sleeve 48 is affixed to the debris chamber housing 44 by threaded connection 50 (FIG. 2). A bottom sub 52 is affixed to the lower end of the housing sleeve 48 by threaded connection 54.

A debris chamber 56 is defined radially between the tool mandrel 12 and the debris chamber housing 44. The debris chamber 56 is bounded axially by the flow entry sub 28 at its upper end and by a bottom sub 52 at its lower end. One or more magnetic members 58 reside radially within the housing sleeve 48 and are mounted upon the tool mandrel 12. In one embodiment, the magnetic members 58 may comprise elongated rods or bars that are removably affixed to the tool mandrel 12 by spacer 60.

The upper and lower stabilizers 40, 42 are rotationally mounted upon the debris chamber housing 44 by means of rotational bearings 62, as best shown in FIG. 4. The bearings 62 permit the upper and lower stabilizers 40, 42 and entire brush portion 38 to rotate freely with respect to the chamber housing 44. The upper and lower stabilizers 40, 42 are affixed to an intermediate support ring 64 by threaded connections 66, 68, as best seen in FIG. 4, and, as a result, the support ring 64 will also rotate with respect to the chamber housing 44.

Radially surrounding the intermediate ring 64 is a series of stacked brushes 70 and spacers 72. Exemplary brushes 70 and spacers 72 are shown in an exploded fashion. As can be seen, the brushes 70 are each made up of a central base ring 74 and bristles 76 which extend radially outwardly from the base ring 74. The brushes 70 and spacers 72 are disposed about the intermediate ring 64 in an alternating fashion so that a spacer 72 is located axially between each two brushes 70. A compression nut 78 is affixed by threaded connection 80 (see FIG. 4) to the intermediate ring 64 to retain the brushes 70 and spacers 72 in axially compressed fashion upon the ring 64. When assembled, the lowermost brush 70 is retained in locked contact against the lower stabilizer 42 by axial compression exerted by the compression nut 78. Due to the threaded assembly of the compression nut 78 and the housing 44, the brushes 70 and spacers 72 may be readily released from the housing 44 by reversing the nut 78 from the housing 44. It can be seen with reference to FIGS. 1, 3 and 4, that, when assembled, the bristles 76 of the brushes 70 extend radially outwardly beyond the diameter D1.

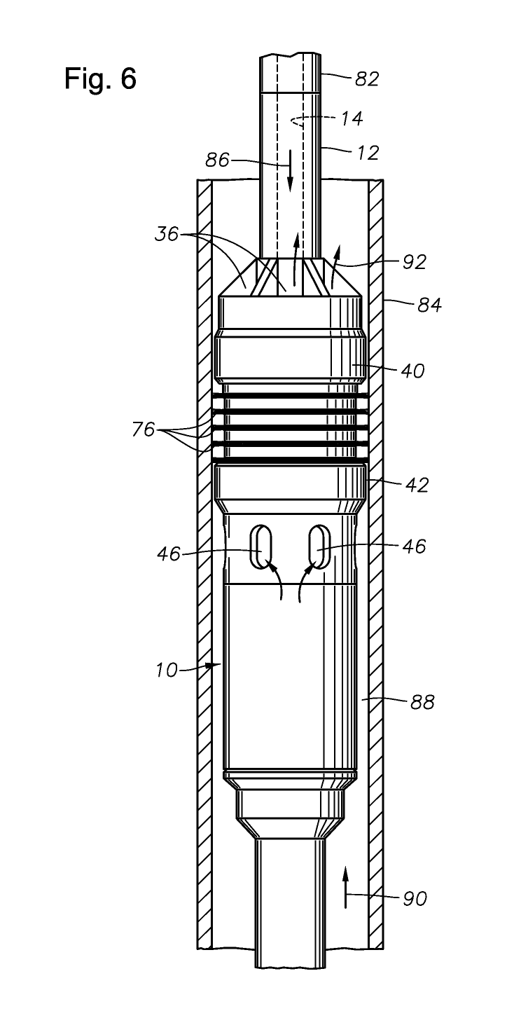

During operation, as illustrated in FIG. 6, the brush assembly 10 is incorporated into a tool string 82 used for the cleaning of a surrounding tubular 84. The brush assembly 10 is disposed into the tubular 84 to be cleaned. It is preferred that the diameter D1 of the stabilizers 40, 42 approximate the drift diameter for the tubular 84 being cleaned. As a result, the bristles 76 of the brushes 70 will extend outwardly beyond drift diameter and preferably contact the surrounding tubular 84. The tool mandrel 12 is then rotated by the tool string 82. Due to the rotational interface provided by bearings 62, the tool mandrel 12 is free to rotate with respect to the stabilizers 40, 42, intermediate ring 64, brushes 70 and spacers 72. As a result, when the tool mandrel 12 is rotated by the tool string, the bristles 76 of the brushes 70 will clean the surrounding tubular 84 and will be subjected to less severe damage and wear than they would be if they were to be forced to rotate along with the mandrel 12.

As debris is removed from the surrounding tubular member 84 by the brushes 70, a portion of the debris will be collected within the debris chamber 56. During a cleaning operation, fluid is circulated downwardly through the flowbore 14 (in the direction of arrow 86 in FIG. 6) as the tool mandrel 12 is rotated by the tool string. The fluid will exit the flowbore 14 at some point below the tool 10 and enter the annulus 88 that is formed between the tubular 84 and the tool string 82. Fluid returns will travel upwardly through the annulus 88, as illustrated by the arrow 90 in FIG. 6. This fluid will enter the brush assembly 10 through the debris windows 46 into the debris chamber 56. Fluid will exit the debris chamber 56 through the fluid flow passages 36 (illustrated by arrows 92) and reenter the annulus 88. As the fluid flow through the tool 10 occurs, metallic debris carried by the fluid is attracted by the magnetic member(s) 58 and thereby retained within the debris chamber 56. Therefore, when the brush assembly 10 is removed from the surrounding tubular, the collected debris can be removed from the chamber 56.

It should be understood, as reference to FIG. 6 indicates, that the presence of stabilizers 40, 42 with a diameter (D1) that approximates drift diameter and brushes 70 with bristles 76 that extend outwardly beyond drift diameter will cause essentially all fluid flow 90 to be directed into the debris chamber 56 through windows 46.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention.

What is claimed is:

1. A brush assembly for cleaning a surrounding tubular member and comprising:
a tool mandrel;
a debris chamber mounted upon the tool mandrel for collection of debris removed from the surrounding tubular member, the debris chamber having a debris chamber housing having an outer radial surface;
a brush portion mounted upon the outer radial surface of the debris chamber and rotationally moveable with respect to the debris chamber, the brush portion comprising:
a brush having an annular base ring and a plurality of bristles that extend radially outwardly from the base ring to remove debris from the surrounding tubular; and
a stabilizer in contact with the brush.

2. The brush assembly of claim 1 further comprising a rotational bearing disposed between the brush portion and the debris chamber.

3. The brush assembly of claim 1 wherein the brush portion further comprises a compression nut which axially compresses the brush against the stabilizer.

4. The brush assembly of claim 2 wherein the brush portion further comprises a support ring that resides radially within the brush and stabilizer and wherein the rotational bearing is disposed between the support ring and the debris chamber.

5. The brush assembly of claim 1 wherein the brush portion further comprises:
a plurality of brushes, each of said brushes having an annular base ring and a plurality of bristles that extend radially outwardly from the base ring to remove debris from the surrounding tubular; and
a spacer disposed axially between each two of said brushes.

6. The brush assembly of claim 1 further comprising a magnet located within the debris chamber for retaining metallic debris within the debris chamber.

7. The brush assembly of claim 1 wherein:
the stabilizer presents a first diameter; and
the bristles of the brush extend to a second diameter that is greater than the first diameter.

8. The brush assembly of claim 7 wherein the first diameter approximates drift diameter.

9. The brush assembly of claim 1 wherein the debris chamber is defined within a debris chamber housing that radially surrounds the tool mandrel and has a plurality of debris windows defined therein.

10. The brush assembly of claim 9 further comprising a flow entry sub that radially surrounds the tool mandrel and is affixed to the debris chamber housing, the flow entry sub providing a flow passage into the debris chamber from an area surrounding the brush assembly.

11. A brush assembly for cleaning a surrounding tubular member and comprising:
a tool mandrel;
a debris chamber mounted upon the tool mandrel for collection of debris removed from the surrounding tubular member, the debris chamber having a debris chamber housing having an outer radial surface;
a brush portion mounted upon the outer radial surface of the debris chamber and rotationally moveable with respect to the debris chamber, the brush portion comprising:
a brush having an annular base ring and a plurality of bristles that extend radially outwardly from the base ring to remove debris from the surrounding tubular;
a stabilizer in contact with the brush; and
a compression nut which axially compresses the brush against the stabilizer.

12. The brush assembly of claim 11 further comprising a rotational bearing disposed between the brush portion and the debris chamber.

13. The brush assembly of claim 11 wherein the brush portion further comprises a support ring that that resides radially within the brush and stabilizer and wherein the rotational bearing is disposed between the support ring and the debris chamber.

14. The brush assembly of claim 11 wherein the brush portion further comprises:
a plurality of brushes, each of said brushes having an annular base ring and a plurality of bristles that extend radially outwardly from the base ring to remove debris from the surrounding tubular; and
an annular spacer disposed axially between each two of said brushes.

15. The brush assembly of claim 11 further comprising a magnet located within the debris chamber for retaining metallic debris within the debris chamber.

16. The brush assembly of claim 11 wherein:
the stabilizer presents a first diameter; and
the bristles of the brush extend to a second diameter that is greater than the first diameter.

17. The brush assembly of claim 11 wherein the first diameter approximates drift diameter.

18. A brush assembly for cleaning a surrounding tubular member and comprising:
a tool mandrel;
a debris chamber mounted upon the tool mandrel for collection of debris removed from the surrounding tubular member, the debris chamber having a debris chamber housing having an outer radial surface;
a brush portion mounted upon the outer radial surface of the debris chamber and rotationally moveable with respect to the debris chamber, the brush portion comprising:
a plurality of brushes, each of said brushes having an annular base ring and a plurality of bristles that extend radially outwardly from the base ring to remove debris from the surrounding tubular;
two stabilizers, each of said stabilizers radially surrounding the debris chamber and at least one of said stabilizers in contact with the annular base ring of one of said brushes;
a compression nut which axially compresses the brushes between the stabilizers;
a support ring which resides radially within the brushes, stabilizers and compression nut; and
a rotational bearing disposed between the support ring and the debris chamber to provide for ease of rotational movement between the brush portion and the debris chamber.

19. The brush assembly of claim 18 further comprising a magnet located within the debris chamber for retaining metallic debris within the debris chamber.

20. A brush assembly for cleaning a surrounding tubular member and comprising:
a tool mandrel;
a debris chamber mounted upon the tool mandrel for collection of debris from the surrounding tubular member, the debris chamber having a debris chamber housing having an outer radial surface;
a brush portion mounted upon the outer radial surface of the debris chamber and rotationally moveable with respect to the debris chamber, the brush portion comprising:
a stabilizer having an outer diameter that approximates drift diameter;
a brush having a plurality of bristles that extend radially outwardly beyond the to outer diameter of the stabilizer; and
wherein the brush portion directs substantially all annular fluid flow through the debris chamber.

21. The brush assembly of claim 20 wherein the brush comprises:
an annular base ring; and
the plurality of bristles extend radially outwardly from the base ring.

22. The brush assembly of claim 20 further comprising a magnet located within the debris chamber for retaining metallic debris within the chamber.
